(19) United States
(12) Patent Application Publication
(10) Pub. No.: US 2025/0334046 A1
(43) Pub. Date: Oct. 30, 2025

(54) SYSTEMS AND METHODS FOR FORECASTING FUTURE EXCURSIONS IN HYDROCARBON PROCESSING SYSTEMS USING SENSOR DATA

(71) Applicant: BP Corporation North America Inc., Houston, TX (US)

(72) Inventors: Cristian Cernatescu, Middlesex (GB); Casey Warshauer, Houston, TX (US); Shaojun Wang, Katy, TX (US); Martin Gonzalez, Mokena, IL (US)

(73) Assignee: BP Corporation North America Inc., Houston, TX (US)

(21) Appl. No.: 19/187,133

(22) Filed: Apr. 23, 2025

Related U.S. Application Data
(60) Provisional application No. 63/638,762, filed on Apr. 25, 2024.

(51) Int. Cl. E21B 47/12

(52) U.S. Cl. CPC E21B 47/12; E21B 2200/20; E21B 2200/22

(57) ABSTRACT

A method for predicting a future excursion in a hydrocarbon processing system includes obtaining a plurality of sensor datasets from a corresponding plurality of different sensor units of the hydrocarbon processing system, wherein a sensor dataset N of the plurality of sensor datasets corresponds to a sensor unit N of the plurality of different sensor units; applying each of the plurality of sensor datasets to a corresponding plurality of predictive models contained by an ensemble model, wherein the sensor dataset N corresponds to a predictive model N of the plurality of predictive models; providing by the plurality of predictive models a plurality of separate prediction outputs based on the plurality of sensor datasets; and providing by the ensemble model a final prediction output regarding an occurrence of the future excursion that is based on each of the plurality of separate prediction outputs of the predictive models.

### CROSS-REFERENCE TO RELATED APPLICATIONS

This application claims benefit of U.S. provisional patent application No. 63/638,762 filed Apr. 25, 2024, entitled “Systems and Methods for Forecasting Future Excursions In Hydrocarbon Processing Systems Using Sensor Data”, which is incorporated herein by reference in its entirety.

### STATEMENT REGARDING FEDERALLY SPONSORED RESEARCH OR DEVELOPMENT

Not applicable.

### BACKGROUND

Hydrocarbon processing systems, encompassing drilling systems, production systems, pipelines, refineries, and downstream processing plants, and the like are critical components of the energy industry. Hydrocarbon processing systems include various types of mechanical, fluidic, electrical, and other equipment for extracting, processing, transporting, distributing, etc., hydrocarbons. This equipment can include fluid conduits, valving, pressure vessels, centrifuges, rotating equipment, actuators, instrumentation, sensors, and control systems. Ensuring the safe and efficient operation of these systems is paramount to maximizing productivity and minimizing operational disruptions. Such hydrocarbon processing systems often implement complex methods or workflows in which the loss of a single piece of equipment can take the entire hydrocarbon processing system offline thus resulting in significant disruption to the operation of the hydrocarbon processing system. In addition, the materials handled by hydrocarbon processing systems may be at elevated pressures and temperatures, making the failure of equipment of a hydrocarbon processing system potentially dangerous to personnel of the hydrocarbon processing system.

### SUMMARY

Methods and systems for forecasting future excursions in hydrocarbon processing systems using sensor data are disclosed herein. In an embodiment, a method for predicting a future excursion in a hydrocarbon processing system comprises obtaining a plurality of sensor datasets from a corresponding plurality of different sensor units of the hydrocarbon processing system, wherein a sensor dataset N of the plurality of sensor datasets corresponds to a sensor unit N of the plurality of different sensor units; applying each of the plurality of sensor datasets to a corresponding plurality of predictive models contained by an ensemble model, wherein the sensor dataset N corresponds to a predictive model N of the plurality of predictive models; providing by the plurality of predictive models a plurality of separate prediction outputs based on the plurality of sensor datasets; and providing by the ensemble model a final prediction output regarding an occurrence of the future excursion that is based on each of the plurality of separate prediction outputs of the predictive models. In some embodiments, each of the plurality of predictive models is configured to predict the future excursion based on data corresponding to the hydrocarbon processing system. In certain embodiments, the plurality of predictive models comprises a voting classifier of ensemble models. In other embodiments, each of the plurality of predictive models comprises similar or different models. In some embodiments, the hydrocarbon processing system comprises an artificial lift or gas lift system. In certain embodiments, the future excursion includes gas lift plugging. In other embodiments, a prediction window of the future excursion comprises less than 12 hours, 12 hours, or greater than 12 hours in advance of the future excursion. In some embodiments, data captured by the plurality of different sensors units comprises time series data. In certain embodiments, the time series data comprises pressure data, temperature data, or flow rate data. In other embodiments, the final prediction output is based on a predefined threshold that is same or different from a majority of the plurality of predictive models.

In an embodiment, a method for predicting a future excursion in a hydrocarbon processing system comprises obtaining a plurality of sensor datasets from one or more different sensor units of the hydrocarbon processing system; applying each of the plurality of sensor datasets to a corresponding plurality of predictive models contained by an ensemble model, wherein each of the predictive models of the plurality of predictive models are of the same model class; providing by the plurality of predictive models a plurality of separate prediction outputs based on the plurality of sensor datasets; and providing by the ensemble model a final prediction output regarding an occurrence of the future excursion that is based on each of the plurality of separate prediction outputs of the predictive models.

In some embodiments, each of the plurality of predictive models is configured to predict the future excursion based on data corresponding to the hydrocarbon processing system. In certain embodiments, the plurality of predictive models comprises a voting classifier of ensemble models. In other embodiments, the hydrocarbon processing system comprises an artificial lift or gas lift system. In some embodiments, the future excursion includes gas lift plugging. In certain embodiments, a prediction window of the future excursion comprises less than 12 hours, 12 hours, or greater than 12 hours in advance of the future excursion. In other embodiments, data captured by the one or more different sensors units comprises time series data. In some embodiments, the time series data comprises pressure data, temperature data, or flow rate data. In certain embodiments, the final prediction output is based on a predefined threshold that is same or different from a majority of the plurality of predictive models.

In an embodiment, a system for predicting a future excursion in a hydrocarbon processing system comprises a one or more processors; and a storage device coupled to the one or more processors, the storage device configured to store instructions that, when executed by the one or more processors, configure the one or more processors to obtain a plurality of datasets from a corresponding plurality of different sensor units of the hydrocarbon processing system, wherein a sensor dataset N of the plurality of sensor datasets corresponds to a sensor unit N of the plurality of different sensor units; apply each of the plurality of sensor datasets to a corresponding plurality of predictive models contained by an ensemble model, wherein the sensor dataset N corresponds to a predictive model N of the plurality of predictive models; provide by the plurality of predictive models a plurality of separate prediction outputs based on the plurality of sensor datasets; and provide by the ensemble model a final prediction output regarding an occurrence of the future excursion that is based on each of the plurality of separate prediction outputs of the predictive models.

In an embodiment, a system for predicting a future excursion in a hydrocarbon processing system comprises a fluid processing system comprising a plurality of equipment; a plurality of sensors units, wherein a sensor unit of the plurality of sensor units is coupled to an equipment of the plurality of equipment; and a computing device comprising a one or more processors; and a storage device coupled to the one or more processors, the storage device configured to store instructions that, when executed by the one or more processors, configure the one or more processors to obtain a plurality of datasets from a corresponding plurality of different sensor units of the hydrocarbon processing system, wherein a sensor dataset N of the plurality of sensor datasets corresponds to a sensor unit N of the plurality of different sensor units; apply each of the plurality of sensor datasets to a corresponding plurality of predictive models contained by an ensemble model, wherein the sensor dataset N corresponds to a predictive model N of the plurality of predictive models; provide by the plurality of predictive models a plurality of separate prediction outputs based on the plurality of sensor datasets; and provide by the ensemble model a final prediction output regarding an occurrence of the future excursion that is based on each of the plurality of separate prediction outputs of the predictive models.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various exemplary embodiments, reference will now be made to the accompanying drawings in which:

FIG. 1 is a schematic view of an embodiment of an artificial lift system in accordance with principles disclosed herein;

FIG. 2 is a block diagram of an embodiment of an excursion forecaster in accordance with principles disclosed herein;

FIG. 3 is a schematic diagram illustrating an embodiment of a voting classifier ensemble model in accordance with principles disclosed here;

FIG. 4 is a schematic diagram illustrating another embodiment of a voting classifier ensemble model in accordance with principles disclosed here;

FIG. 5 is a flowchart illustrating an embodiment of a method for forecasting future excursions in hydrocarbon processing systems using sensor data in accordance with principles disclosed here;

FIG. 6 is a flowchart illustrating another embodiment of a method for forecasting future excursions in hydrocarbon processing systems using sensor data in accordance with principles disclosed here; and

FIG. 7 is a block diagram of an embodiment of a computer system in accordance with principles described.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment. Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a particular axis (e.g., central axis of a body or a port), while the terms “radial” and “radially” generally mean perpendicular to a particular axis. For instance, an axial distance refers to a distance measured along or parallel to the axis, and a radial distance means a distance measured perpendicular to the axis. Any reference to up or down in the description and the claims is made for purposes of clarity, with “up”, “upper”, “upwardly”, “uphole”, or “upstream” meaning toward the surface of the borehole and with “down”, “lower”, “downwardly”, “downhole”, or “downstream” meaning toward the terminal end of the borehole, regardless of the borehole orientation. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

As described above, hydrocarbon processing systems comprise sophisticated and complex networks of various types of equipment. One significant challenge faced by operators of hydrocarbon processing systems is the prediction and mitigation of future excursions in equipment of the hydrocarbon processing system. As used herein, the term “excursion” refers to an inadvertent deviation from a predefined operational range of an operating parameter of a piece of equipment of the hydrocarbon processing system. For example, a pressure vessel of a hydrocarbon processing system may have a predefined operating pressure range extending between a predefined minimum pressure and a predefined maximum pressure. In this example, an excursion would include the pressure of the given pressure vessel departing from its predefined operating pressure range.

Excursions in the equipment of hydrocarbon processing systems may lead to equipment failure, safety hazards, or production losses. Such excursions can arise due to various factors including equipment degradation, process variations, environmental conditions, and unforeseen events. Current techniques for forecasting future excursions in hydrocarbon processing systems typically involve a combination of monitoring, data analysis, and predictive modeling. For example, most hydrocarbon processing systems are equipped with extensive sensor networks that continuously monitor key parameters such as pressure, temperature, flow rates, and chemical composition. These monitoring systems provide real-time data on the current state of equipment and processes, enabling operators to detect abnormalities or deviations from expected performance. In addition, data collected from monitoring systems may be analyzed using advanced analytical techniques such as statistical analysis, machine learning, and pattern recognition. Further, predictive models may be developed based on historical data (e.g., captured by the monitoring system) and operational knowledge to forecast future excursions. These models may include decision trees, physics-based models, empirical models, or hybrid models that combine both approaches. Predictive models are generally intended to allow operators to anticipate potential issues before they occur and take proactive measures to prevent or mitigate them.

Predictive models often take the form of decision trees which split a population of data into smaller segments. Decision trees may make various types of predictions that can take the form of continuous quantitative data (e.g., in the form of a regression tree configured to predict a current operating temperature of a pressure vessel), qualitative data (e.g., in the form of a classification tree configured to predict whether an excursion will occur). Generally, decision trees include a plurality of nodes comprising a root located at the top of the decision tree and a plurality of terminal nodes or leaves located at the opposing bottom of the decision tree and are connected to the root by a plurality of branches of the decision tree. The nodes of the decision tree contain information organized into a plurality of atoms each including a plurality of separate indicators and a target indicator.

As an example, a particular atom may comprise a given piece of equipment (e.g., a pressure vessel) having indicators in the form of measured pressure, measured temperature, etc., and a target indicator in the form of a prediction of whether an excursion in the piece of equipment (e.g., the pressure of the equipment will depart from the equipment's operating pressure range). The root of a decision tree includes the entire population of the decision tree while each node branching directly from the root includes a unique subset of the population of atoms. Each child node branching from a shared parent node will contain a unique subset of the population of atoms contained by the parent node—extending from the root all the way to the leaves of the decision tree.

In some instances, child nodes having the root of the decision tree as their parent node are created by identifying the indicator that has the greatest Gini coefficient with respect to the target indicator. Once this indicator is identified, the first pair of children nodes are created by splitting the population of atoms contained in the parent node (the root in this example) along the selected indicator. This process may be repeated in some instances such that the decision tree includes multiple layers of nodes between the root and the leaves thereof while in other instances the decision tree may only include a root having a pair of child nodes in the form of the leaves of the decision tree.

Conventional predictive models, including decision trees, suffer from several limitations. For example, conventional predictive models often struggle to find the right balance between bias and variance. Predictive models with high bias may underfit the data and fail to capture complex relationships, while predictive models with high variance may overfit the data and perform poorly on unseen data. For instance, a decision tree having too many layers of nodes between the root and leaves may suffer from being overfit to the training data used to create the decision tree. In addition, predictive models trained on limited data may suffer from instability, leading to erratic predictions. Further, single predictive models may be sensitive to outliers, noise, or changes in data distribution, resulting in decreased robustness.

Accordingly, embodiments of systems and methods for forecasting future excursions in hydrocarbon processing systems are disclosed herein which address at least some of the limitations associated with conventional predictive modeling. Particularly, embodiments disclosed herein utilize an ensemble predictive model or simply “ensemble model” comprising a collection of predictive models for forecasting the occurrence of future excursions in hydrocarbon processing systems. Particularly, as used herein, the term “ensemble model” refers to a model that contains a plurality of predictive models and which produces a prediction output that is based on prediction outputs produced by the underlying predictive models contained by the ensemble model. In this manner, the ensemble model combines the outputs of a plurality of predictive models (e.g., decision trees or other types of predictive models such as neural networks, gradient boosting machines, support vector machines, and the like) to mitigate the trade-off in bias and variance by aggregating the predictions of multiple predictive models thereby reducing both bias and variance in the resulting ensemble model. Additionally, ensemble models minimize the impact of individually weak predictive models by combining their output with other predictive models such that the resulting ensemble model is substantially more robust than the predictive models from which it is comprised.

In addition, embodiments of systems and methods for forecasting future excursions in hydrocarbon processing systems disclosed herein include uniquely configured and implemented ensemble models. For example, conventional ensemble models involve creating a collection of unique predictive models using the same training data. This may be done, for example, by adjusting the weights applied to the different atoms (e.g., forming the training data) of the predictive models such that the atoms of a first predictive model have a first distribution of weights while the atoms of a second predictive model have a second distribution of weights that is different from the first distribution. Thus, the data used to create each predictive model of the conventional ensemble model is the same while each predictive model itself is unique through its unique weighting.

However, embodiments of ensemble models disclosed herein contain a plurality of predictive models trained on separate data sets. For example, an embodiment of an ensemble model may be configured to predict an excursion in a hydrocarbon processing system based on a plurality of different training sets corresponding to different pieces of equipment of the hydrocarbon processing system. A first predictive model of the ensemble model may be trained using a first dataset associated with a first piece of equipment (e.g., a pressure sensor of the first piece of equipment); a second predictive model of the ensemble model may be trained using a second dataset associated with a second piece of equipment (e.g., a pressure sensor of the second piece of equipment).

In some embodiments, the ensemble model comprises a voting classifier ensemble model. Specifically, a prediction made by the ensemble model is based on the predictions of each of the predictive models contained by the ensemble model as well as a predefined voting threshold that may vary depending on the given application. For example, if an ensemble model is configured to predict “1” or “0,” the voting threshold may comprise the predefined percentage of the predictive models predicting or “voting” “1” for the ensemble model to vote “1” rather than “0.”

In this example, if the voting threshold is 20% for “1,” and 23% of the predictive models vote “1,” then the ensemble model would in-turn vote “1.” However, in this example, if the voting threshold is 70% for “1,” and 65% of the predictive models vote “1,” then the ensemble model would in-turn vote “0.” This allows the ensemble model to be tuned to the given application. For instance, in a given application the ensemble model may predict whether or not a catastrophic event is to occur and the result of the ensemble model predicting the catastrophic event may be the generation of an alarm to an operator.

In this example, it may be desired for the voting threshold to be low for the “yes” or “1” prediction of the catastrophic event to be low as the cost of an occasional false positive (e.g., the time wasted by personnel required to check on the alarm) is far less than the case of a false negative. However, if the ensemble model is configured to predict the occurrence of a relatively less important event with the outcome being the automatic shutdown of a piece of equipment, then it may be desired to have a voting threshold that is substantially higher as the cost of a false positive may be greater than the cost of a false negative.

As will be discussed further herein, embodiments of systems and methods for forecasting future excursions in hydrocarbon processing systems are discussed herein in the context of predicting an excursion in the form of a plugging event in a hydrocarbon processing system in the form of an artificial lift system. However, it may be understood that embodiments of systems and methods for forecasting future excursions in hydrocarbon processing systems disclosed herein (including embodiments of ensemble models disclosed herein) may extend beyond predicting plugging events in artificial lift systems.

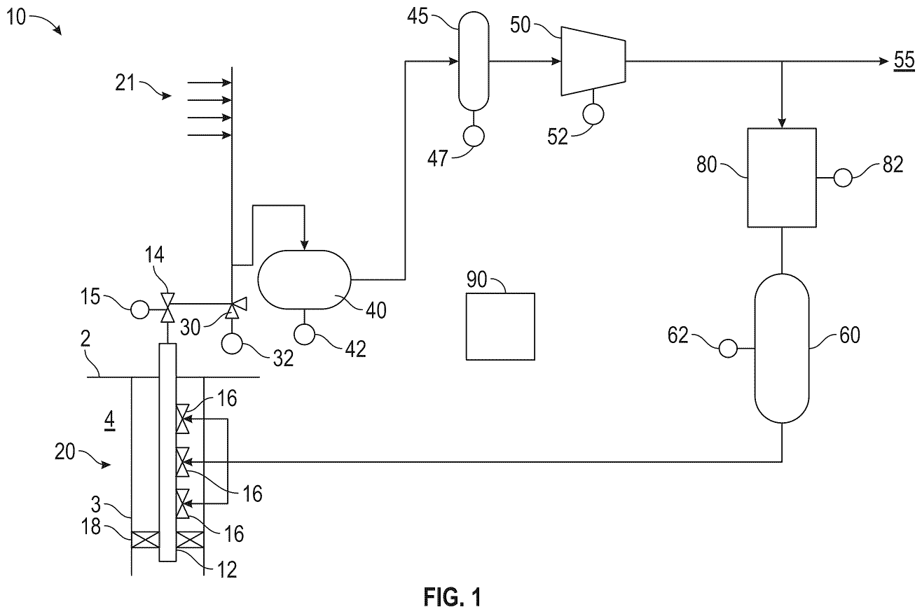

Referring now to FIG. 1, an embodiment of a hydrocarbon processing system in the form of an artificial or “gas” lift system 10 in a vertical wellbore is shown. Artificial lift system 10 is generally configured to extract hydrocarbons from a wellbore 20 that extends from a terranean surface 2 and into a subterranean earthen formation 4. In this exemplary embodiment, artificial lift system 10 generally includes a casing string 3 positioned in the wellbore 20, production tubing 12 extending within the casing string 3, production valve 14 (e.g., constant pressure valve), a plurality of gas lift valves 16, a packer assembly 18, a production choke 30, a separation unit 40, a scrubber unit 45, a compression unit 50, a dehydrator 60 (e.g., a glycol contactor), a thermal conditioning unit 80 (e.g., a cooler, a heater, and/or a heat exchanger), and an excursion forecaster 90. Artificial lift system 10 may also include any suitable equipment for supporting or facilitating transportation of fluids, tools into and from the wellbore 20 (e.g., well head, one or more pumps, etc.).

Terranean surface 2 may be a land surface, a sub-sea surface (e.g., a seabed), or other underwater surface. As shown in FIG. 1, wellbore 20 extends vertically from an uphole end thereof located at terranean surface 2, into the subterranean earthen formation 4 along a central or longitudinal axis to a downhole end located within subterranean earthen formation 4. In this configuration, wellbore 20 provides access to hydrocarbons or other formation fluids in the subterranean earthen formation 4. While wellbore 20 is shown in FIG. 1 as substantially vertical, it should be appreciated that in other embodiments, wellbore 20 may be deviated and extend at an incline relative to the direction of gravity along one or more sections of the deviated wellbore. Additionally, wellbore 20 may be formed with various dimensions (e.g., diameter, depth). It may also be understood that wellbore 20 is formed using a drilling system not shown in FIG. 1 which may include, among other things, a support structure (e.g., a derrick, a mast) located at the terranean surface 2, and a drilling assembly deployable into the subterranean earthen formation 4 including a drill bit for cutting into the subterranean earthen formation 4 and which is coupled to a downhole end of a drill string suspended from the surface support structure.

Casing string 3 of artificial lift system 10 extends axially from a first or uphole end located at or proximate to terranean surface 2 into wellbore 20, to a second or downhole end within subterranean earthen formation 4 of wellbore 20. Casing string 3 provides structural support to wellbore 20 while controlling the communication of formation fluids from subterranean earthen formation 4 to a central passage of casing string 3. In this exemplary embodiment, casing string 3 is secured to a generally cylindrical sidewall of wellbore 20 via cement or any other suitable material that has been pumped into the annulus formed between an outer surface of casing string 3 and the sidewall of wellbore 20. Casing string 3 may comprise a plurality of steel casing string joints that are coupled end-to-end and installed in the wellbore 20 via a drilling system not shown in FIG. 1. Casing string 3 may be perforated at certain locations along its longitudinal length to facilitate the flow of fluids in and out of the subterranean earthen formation 4 into the wellbore 20.

Production tubing 12 of the artificial lift system 10 is installed within the central passage of the casing string 3 and extends axially from a first or uphole end located at or proximate to terranean surface 2 to a second or downhole end located within subterranean earthen formation 4. Production tubing 12 provides a fluid conduit for hydrocarbons and/or other formation or wellbore fluids to flow from the subterranean earthen formation 4 to the terranean surface 2. Production tubing 12 may be centralized and secured in the central passage of the casing string 3 via a tubing hanger coupled to a support structure (e.g., a well head, a casing string head etc.) disposed at the terranean surface 2. In this configuration, an annulus is formed between the casing string 3 and the production tubing 12 within the wellbore 20. In some embodiments, production tubing 12 may comprise a plurality of steel tubing joints that are coupled end-to-end and installed within the casing string 3 of wellbore 20.

Production valve 14 of the artificial lift system 10 may be installed at the terranean surface 2 proximate the well head or in a flow line from the well head into one or more equipment of the artificial lift system 10. Production valve 14 may be used to isolate a central passage of production tubing 12 from the external environment at the terranean surface 4 and control the flow of fluids (hydrocarbons, lift gas, water) produced from the wellbore 20. Production choke 30 is located downstream from production valve 14 along a production flowpath of artificial lift system 10 and is configured to regulate the flow of fluid into the production tubing 12 and maintain the pressure in production tubing 12 at a predefined pressure regardless of changes or fluctuations in the wellbore 20 (e.g., changes in production rate). In some embodiments, production choke 30 may adjust the flow rate through the production choke 30 responsive to changes in upstream pressure (i.e., pressure exerted on the wellbore or formation fluid), thereby maintaining a constant pressure downstream (i.e., pressure of the wellbore or formation fluids as it flows towards the terranean surface 2).

In general, gas lift valves 16 may be installed along the production tubing 12 at or proximate depths where gas injection is required to lift formation fluid (e.g., hydrocarbons) through the production tubing 12 to the terranean surface 2. Gas lift valves 16 may be coupled to production tubing 12, for example, using threaded connections or gas lift mandrels to thereby secure the gas lift valves 16 to the production tubing 12. In this manner, gas lift valves 16 allow for control of the timing and volume of gas injection required to optimize production rates and lift efficiency of fluids in the wellbore 20. Gas lift valves 16 may be controlled using mechanical, hydraulic, pneumatic and/or electrical systems. For example, gas lift valves 16 may operate based on the pressure differential between the tubing (e.g., production tubing 12) and the annulus (e.g., between production tubing 12 and casing string 3) within wellbore 20. In this manner, when pressure at the inlet (in fluid communication with the annulus) of a given gas lift valve 16 exceeds pressure at the outlet (in fluid communication with the production tubing 12), the gas lift valve 16 opens allowing gas to be injected into production tubing 12. Conversely, when the pressure at the outlet exceeds pressure at the inlet of the gas lift valve 16, the gas lift valve 16 closes thereby preventing gas from flowing into production tubing 12.

The production tubing 12 may be connected or sealably coupled to packer assembly 18. The packer assembly 18 provides downhole pressure isolation within wellbore 20 which allows the annulus formed between the casing string 3 and the production tubing 12 to increase in pressure from the lift gas delivered by gas lift valves 16. As used herein, “lift gas” refers gas injected into the wellbore to lift or drive the hydrocarbons to be produced at the terranean surface. As described above, when the pressure at the inlet of the gas lift valves 16 exceeds pressure at the outlet, the gas lift valves 16 open allowing the lift gas to flow into production tubing 12 from the annulus formed between the production tubing 12 and the casing string 3. In this manner, the lift gas comingles with the formation fluid (e.g., hydrocarbons) in the wellbore 20 forming a combined fluid. By combining the lift gas with the formation fluid, the lift gas serves to decrease the density of the formation fluid thereby allowing the formation fluid to rise vertically through the production tubing 12 and flow up the wellbore 20 and out to the terranean surface 2.

In general, the separation unit 40 of artificial lift system 10 may be installed at the terranean surface 2 proximate the wellbore 20 to receive the combined fluid (hydrocarbons, lift gas, water). In some embodiments, separation unit 40 may comprise multiple stages and is generally configured to separate the combined fluids received from wellbore 20 into individual components. For example, separation unit 40 may separate the combined fluid into liquid and gas (e.g., a two-phase separator) or into oil, water and gas (e.g., a three-phase separator). In this manner, separation unit 40 may separate the gas from the liquid (oil and water) allowing the gas to be further processed before sale or reinjecting as lift gas. In addition to separating combined fluids received from wellbore 20, separation unit 40 may similarly separate combined fluids received from other wellbores 21 as well.

In some embodiments, separation unit 40 includes a separator sensor unit 42 for monitoring various parameters of the separation unit 40. For example, separator sensor unit 42 may monitor and capture data associated with fluid levels and composition (e.g., composition of hydrocarbon, lift gas, water) in the separation unit 40, temperature of the fluids in the separation unit 40, and pressure inside the separation unit 40. The data captured by separator sensor unit 42 may be monitored and used to ensure that the separation unit 40 is operating within operational limits, for process control purposes and to thereby maintain separation efficiency.

Scrubber unit 45 of artificial lift system 10 is configured to remove dirt, fluids, particles, and other contaminants from the gas that could potentially damage other equipment of artificial lift system 10. Scrubber unit 45 contains a scrubbing fluid (e.g., water, corrosion and scale inhibitors, surfactants, etc.) designed to capture or absorb contaminants in the gas. The actual composition of a scrubbing fluid may vary depending on the characteristics of the fluid in the gas lift system. In this manner, scrubber unit 45 helps protect equipment downstream of the scrubber unit 45 (e.g., compressor, dehydrator, etc.) from damage.

In some embodiments, scrubber unit 45 includes a scrubber sensor unit 47 for monitoring various parameters of the scrubber unit 45. For example, scrubber sensor unit 47 may monitor and capture data associated with liquid level and composition of fluid entering and exiting the scrubber unit 45, temperature of the fluids in the scrubber unit 45, and pressure inside the scrubber unit 45. The data captured by scrubber sensor unit 47 may be monitored and used to ensure that the scrubber unit 45 is operating within operational limits, for process control purposes. Particularly, the data captured by scrubber sensor unit 47 may be used to predict future excursions in hydrocarbon processing systems (e.g., gas lift systems). For example, data captured by scrubber sensor unit 47 may be used to predict issues such as hydrate formation, gas plugging, etc. in the gas lift system.

Compression unit 50 of artificial lift system 10 is coupled to the scrubber unit 45 (or in some cases, directly to separation unit 40) such that the gas separated from the combined fluid by separation unit 40 is allowed to enter compression unit 50 for further treatment and processing. Compression unit 50 may comprise multiple stages where, for example, artificial lift system 10 may include one or more compression units 50 such that a separate portion of the gas from the scrubber unit 45 is handled by each compression unit 50. In this manner, the compression process is divided into multiple stages to achieve greater pressure ratios at the compression unit 50. For example, compression unit 50 may be configured to compress the separated gas into compressed gas and thereby increase the pressure of the gas for transportation and handling. In this manner, a portion of the compressed gas may be transported for sale (e.g., through outlet 55) and/or lifting hydrocarbons from the wellbore 20 at high pressure. In some embodiments, compression unit 50 includes a compressor sensor unit 52 for monitoring various parameters of compression unit 50. For example, compressor sensor unit 52 may monitor and capture data associated with temperature, pressure and flow rate of fluid flowing through compression unit 50. Monitoring and capturing data by compressor sensor unit 52 may allow operators detect deviations from normal or predefined parameters of the compressed gas which may indicate future plugging in the hydrocarbon processing system.

Dehydrator 60 (e.g., glycol contactor) of artificial lift system 10 is coupled to compression unit 50 and configured to remove moisture or water vapor from the gas received from separation unit 40 and/or scrubber unit 45 before the gas enters equipment downstream from dehydrator 60. For example, artificial lift system 10 may include one or more compression units 50 positioned upstream from dehydrator 60 and/or one or more additional compression units 50 positioned downstream from dehydrator 60.

The dehydrator 60 may remove moisture or water vapor in the gas by using for example, a glycol desiccant. As the gas passes through the dehydrator 60 and contacts the glycol, it releases water vapor to the glycol forming dry gas. Before leaving the dehydrator, the dry gas may pass through an extractor of dehydrator 60 to remove glycol in the dry gas. The glycol that is separated from the dry gas may be sent to a glycol storage unit for later use while the dry gas is sent for further processing. In some embodiments, dehydrator 60 may include a dehydrator sensor unit 62 for monitoring and controlling parameters of dehydrator 60. In some embodiments, dehydrator sensor unit 62 monitors and captures data associated with moisture content, flow rate, temperature, and/or pressure of the dry gas. For example, flow sensors may be coupled to dehydrator 60 and configured to capture flow rate of the glycol which may be used to predict excursions or deviations in flow rate that may be used to forecast blockages or plugging in the gas lift system.

The thermal conditioning unit 80 of artificial lift system 10 may be used to adjust a temperature of the dry lift gas before being re-injected into the wellbore 20. However, it may be understood that the number, location, and specific function (e.g., heating, cooling) of thermal conditioning unit 80 may vary. For instance, the exact locations of the thermal conditioning unit 80 may depend on the requirements of the systems and the nature of the gas being processed. The thermal conditioning unit 80 may comprise one or more heat exchangers, heaters, and/or coolers depending on the requirements of the artificial lift system 10. In a first example, after compression, the gas may generate heat and thus cooling of the gas may be required to maintain optimal temperature conditions for the gas lift process. In a second example, heat exchangers may be used to heat the glycol or desiccants used in the dehydrator. In a third example, dehydrator 60 may require cooling to facilitate condensation or removal of liquids from the combined gas produced at the terranean surface 2 before further processing. In some embodiments, thermal conditioning unit 80 may include a thermal conditioning sensor unit 82 for monitoring and capturing data associated with the thermal conditioning unit 80 such as, for example, pressure, and temperature of the gas. The sensor data collected from thermal conditioning sensor unit 82 may be used to detect issues such as overheating, insufficient cooling, etc. in the artificial lift system 10. As used herein, the term “sensor data” refers to information or data obtained as an output from a sensor that is associated with (e.g., correlated with) a physical phenomenon estimated or measured by the sensor.

As described above, artificial lift system 10 includes various sensor units collecting sensor data (e.g., time-series data) from various pieces of equipment. For instance, artificial lift system 10 includes sensor units 42, 47, 52, 62, and 82 as described above. In addition, artificial lift system 10 also includes a production sensor unit 15 coupled to production valve 14, and a choke sensor unit 32 coupled production choke 30. Production sensor unit 15 monitors and collects sensor data associated with production valve 14 (e.g., pressure, temperature, valve position) while choke sensor unit 32 monitors and collects sensor data associated with production choke 30 (e.g., pressure, temperature, flowrate and choke position). The sensor units (e.g., sensor units 15, 32, 42, 47, 52, 62, and 82) utilized in the exemplary gas lift system 10 may include transmitters that provide the captured data to one or more computer systems.

In this exemplary embodiment, the sensor units of artificial lift system 10 provide captured sensor data to a computer system in the form of the excursion forecaster 90 such that excursion forecaster 90 is in signal communication with the sensor units of artificial lift system 10. Particularly, data captured by the sensor units may be used by excursion forecaster 90 to make real-time or near real-time predictions regarding one or more future excursions in the artificial lift system 10. The prediction made by excursion forecaster 90 may act as an early warning for personnel of artificial lift system 10 allowing them to take preventive action to avoid an undesirable outcome or event. In some embodiments, excursion forecaster 90 is configured to predict in real-time or near real-time, using sensor data provided by sensor units of artificial lift system 10, a plugging event in artificial lift system 10 whereby a fluid flow path of artificial lift system 10 (e.g., gas lift valve 16 and/or other locations) becomes plugged, limiting or halting the production of hydrocarbons from wellbore 20.

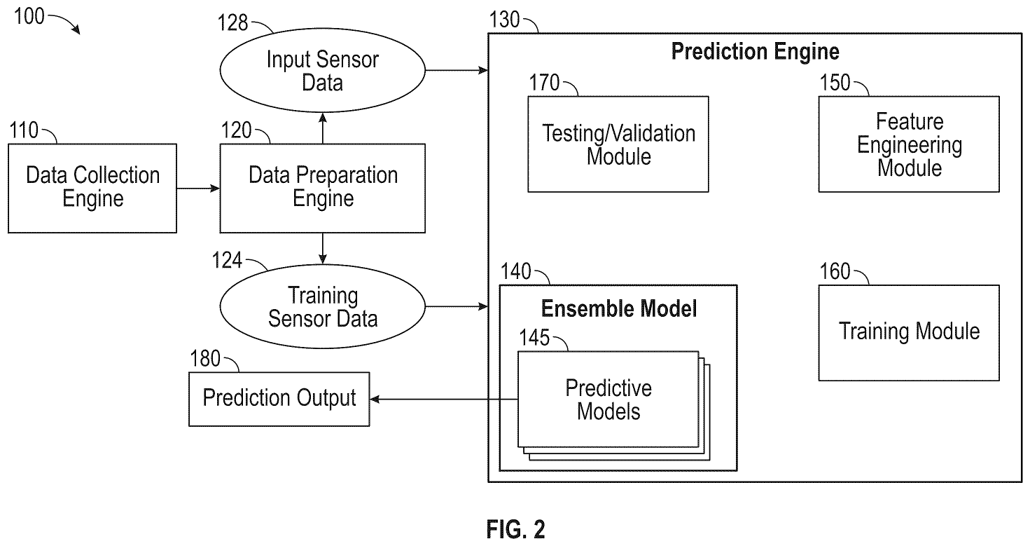

Referring to FIG. 2, an embodiment of a computer system in the form of an excursion forecaster 100 is shown. The excursion forecaster 90 of artificial lift system 10 may be configured similarly as excursion forecaster 100 in some embodiments. However, in other embodiments, excursion forecaster 90 may vary in configuration from excursion forecaster 100. In addition, excursion forecaster 100 may be used to predict or forecast excursions in hydrocarbon processing systems that vary in configuration or function from the artificial lift system 10 shown in FIG. 1. For example, the excursion forecaster 100 shown in FIG. 2 may be used in various types of hydrocarbon processing systems including, for example, onshore and offshore systems, drilling systems, completion systems, production systems, transportation (e.g., pipeline) systems, and refining or processing systems. In this exemplary embodiment, excursion forecaster 100 generally includes a prediction engine 130 configured to produce a prediction output 180 based on input sensor data 128 and training sensor data 124. The Excursion forecaster 100 includes a data collection engine 110, a data preparation engine 120, and Prediction engine 130. An ‘engine’ as used herein, refers to a functionality implemented by a software executed on one or more computing devices, hardware processors, or specially-designed hardware (e.g., field-programmable gate array, application-specific integrated circuit). For example, a data collection engine may be software that, when executed by a hardware processor, gathers data relevant to a hydrocarbon processing system.

Data collection engine 110 may be configured to receive, process, and organize sensor data from various components of fluid systems such as hydrocarbon processing systems (e.g., artificial lift system 10). For example, data collection engine 110 may be communicatively coupled to sensor units 15, 32, 42, 47, 52, 62, and 82 of the artificial lift system 10 and configured to receive and gather sensor data from thereof associated with artificial lift system 10. Data collection engine 110 may be implemented to support various sources, for example, databases, sensors, files, etc., and have capability to handle infinite data and integrate with different systems. The data gathered by data collection engine 110 may include pressure, temperature, flow rate, valve position, etc. relevant to operation of different equipment of the hydrocarbon processing system. For example, in an embodiment, data collection engine 110 may collect data associated with scrubber unit 45, compression unit 50, dehydrator 60, thermal conditioning unit 80, and/or other equipment of artificial lift system 10.

In this exemplary embodiment, the sensor data collected by data collection engine 110 comprises time-series data whereby a parameter (e.g., the sensor data) is sampled (continuously, periodically, randomly) by the sensor over a given period of time. In some embodiments, data collection engine 110 may gather historical data and/or current (real-time) data (e.g., data sampled within the past ten seconds by the given sensor(s), data sampled within the past second by the sensor(s), data sampled within the past millisecond by the sensor(s)) associated with artificial lift system 10. Furthermore, data collection engine 110 may generate sensor data identifiers for dataset associated with a particular sensor. For example, data collection engine 110 may organize the data received from a plurality of sensor units coupled to different equipment of a hydrocarbon processing system into independent datasets associated with each sensor unit of the different equipment and generate sensor data identifiers, e.g., S₁, S₂, . . . S_{N} for each independent dataset 1, 2, . . . N associated with sensor unit 1, 2, . . . N respectively. In this manner, data S₁ is associated with independent data set 1 which is the dataset corresponding to, for example, the scrubber unit 45 of gas lift system 10. In some embodiments, the sensor data identifiers associated with each independent dataset may include labels based on whether or not an excursion (e.g., plugging) occurred during the period during or after the data was collected.

The data preparation engine 120 of excursion forecaster 100 receives the data gathered and processed by data collection engine 110. The data preparation engine 120 may be configured to divide or partition each independent dataset received from the data collection engine 110 for inputting to the prediction engine 130. For example, data preparation engine 120 may be used to prepare the sensor data for training and validating a statistical or machine learning model. In this exemplary embodiment, data preparation engine 120 divides an independent dataset received from data collection engine 110 into training sensor data 124 and input sensor data 128. In this manner, training sensor data 124 may be used to train and validate a predictive model (e.g., predictive models 145 of the prediction engine 130) while input sensor data 128 is used to test the models and produce a prediction output. In some embodiments, data preparation engine 120 may be configured to remove or correct errors, outliers, and other anomalies from each of the independent datasets collected by data collection engine 110. Additionally, data preparation engine 120 may in some instances transform and/or organize the independent datasets received from the data collection engine 110 into a format suitable for analysis or machine learning, and standardize the data to ensure consistent scales. Further, it may be understood that in certain embodiments, excursion forecaster 100 may not include data preparation engine 120.

In this exemplary embodiment, prediction engine 130 of excursion forecaster 100 comprises an ensemble model 140, a feature engineering module 150, a training module 160, and a testing/validation module 170. Prediction engine 130 is configured to receive data from the data preparation engine 120 (e.g., in the form of input sensor data 128 and training sensor data 124) and predict a future excursion in a hydrocarbon processing system (e.g., gas lift system 10) based on the training sensor data 124 and input sensor data 128. In at least some embodiments, prediction engine 130 is configured to produce prediction outputs 180 on the basis of only sensor data such as time-series sensor data in the form of training sensor data 124 and input sensor data 128.

In this exemplary embodiment, ensemble model 140 comprises or contains a plurality of predictive models 145. The predictive models 145 are trained using training sensor data (e.g., training sensor data 124) to configure the overarching ensemble model 140 to produce prediction outputs 180 based on input sensor data (e.g., input sensor data 128). For example, the training sensor data may be used to train and test or validate the predictive models 145 contained by ensemble model 140 whereby, once trained, the excursion forecaster 100 may be used to predict future excursions in hydrocarbon processing systems in real-time, based on time-series sensor data. The training of predictive models 145 using training sensor data 124 may improve the performance or accuracy of the ensemble model 140 in predicting future excursions, thereby improving the quality of the prediction output 180 and the performance of excursion forecaster 100.

The prediction window of the future excursion (i.e., the time frame for predicting a future excursion) may comprise less than 12 hours, 12 hours, or greater than 12 hours in advance of the future excursion. For instance, a predictive model with a prediction window of 12 hours may predict the future occurrence of an excursion should the predictive model predict an excursion to occur within the next 12 hours from the making of the prediction. Alternatively, a predictive model with a prediction window of 10 hours may predict the future occurrence of an excursion should the predictive model predict an excursion to occur within the next 10 hours (not 12 hours) from the making of the prediction.

As described above, the ensemble model 140 of prediction engine 130 includes a plurality of predictive models 145 (e.g., decision trees or other types of predictive models such as linear models, neural networks, gradient boosting machines, support vector machines, and the like) which may aggregate their results into one or more predictions in the form of prediction output 180 produced by the ensemble model 140. In an embodiment, the ensemble model 140 may include multiple instances (e.g., 1, 2, 3 . . . N) of a single pre-trained predictive model that is subsequently trained using a plurality of separate or different datasets (i.e. independent datasets from sensors coupled to different equipment). For example, a first instance of the predictive model may be trained using a first sensor dataset, a second instance of the predictive model may be trained using a second sensor dataset that is different from the first sensor dataset (e.g., is unique to the second instance), a third instance of the predictive model may be trained using a third sensor dataset that is different from the first and second sensor datasets, and so on. In this manner, multiple instances of a single predictive model (e.g., a single decision tree model) are trained using unique sensor datasets to thereby produce a plurality of trained predictive models that, while being similarly structured, are different in that they base their predictions on different or unique datasets.

The prediction output 180 produced by ensemble model 140 is based on a combination of underlying prediction outputs produced by the predictive models 145. The ensemble model 140 may aggregate or combine the prediction outputs of predictive models 145 to arrive at the prediction output 180. In some embodiments, ensemble model 140 comprises a voting classifier ensemble model in which the prediction outputs of predictive models 145 are combined or aggregated using a vote. For instance, the voting classifier ensemble model may take a “vote” of the predictive models 145 contained therein, such that the voting classifier ensemble model may offer a particular prediction (e.g., in the form of prediction output 180) should that prediction be shared by a predefined voting threshold (e.g., a predefined percentage) of the predictive models 145 contained therein. For example, if an ensemble model is configured to predict “1” or “0,” the voting threshold may comprise a predefined number or percentage (e.g., 65%, >50%, at least 50%, 70% etc.) of the predictive models predicting or “voting” “1” for the ensemble model to vote “1” rather than “0.”

As described above, prediction engine 130 also includes feature engineering module 150. The feature engineering module 150 enables the predictive models 145 of ensemble model 140 to correctly classify datasets associated with a hydrocarbon processing system. Feature engineering module 150 may be configured to create, transform or select features that are relevant for predicting a future excursion. For example, feature engineering module 150 may extract, create, or modify all of the features of a training data (e.g., training sensor data 124) to improve model performance.

After the features are extracted, feature engineering module 150 may select the best features for new data received. In some embodiments, feature engineering module 150 may be configured to homogenize the feature in different datasets and test samples prior to classification. The feature engineering module 150 may also convert the data (e.g., input sensor data 128) into features that the predictive models can use efficiently. The feature engineering module 150 may also create or highlight patterns in the data to enhance interpretability. For example, feature engineering module 150 may extract relevant features from time-series data received from each sensor unit of a hydrocarbon processing system, for example, feature engineering module 150 may extract relevant features such as trend, seasonality, and autocorrelation. In some embodiments, feature engineering module 150 may be configured to employ techniques (e.g., principal component analysis (PCA)) for dimensionality reduction. Furthermore, feature engineering module 150 may create new features or modify existing features of the data to improve model performance by imputing the mean, median or mode values of data instead of individual data points.

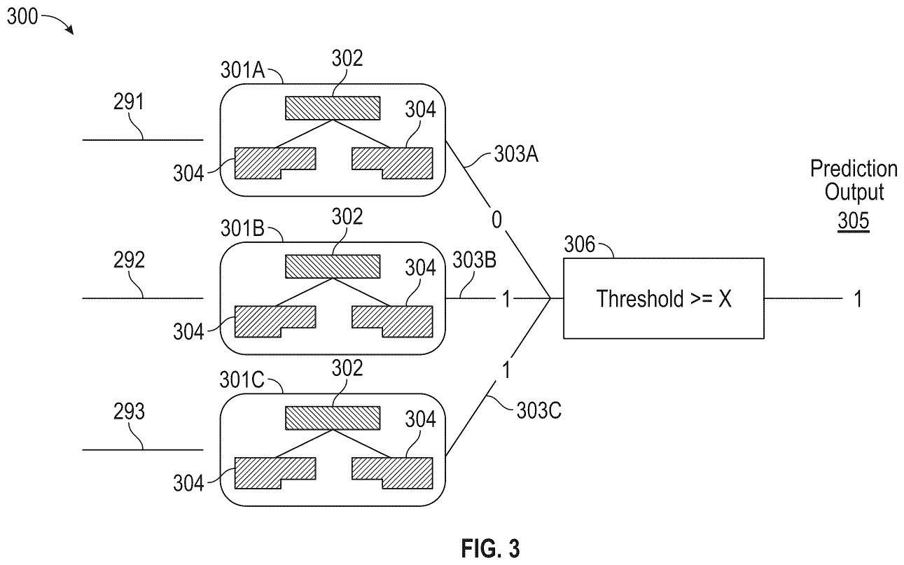

Although shown as separate modules 160 and 170 in FIG. 3, in other embodiments, the training module 160 and testing/validation module 170 of prediction engine 130 may be combined into a single module of prediction engine 130. As described above, the sensor data collected by data collection engine 110 may be partitioned into training data and test data for model training and validation. For example, the training module 160 may be configured to feed the training sensor data into the predictive models 145 of ensemble model 140 and then employ supervised learning, for example, backward propagation to optimize the weights and biases based on the errors. In some embodiments, training module 160 may split the training sensor data (e.g., training sensor data 124) further into a training dataset and a separate validation dataset, where the training dataset is used to train the predictive models 145 and the validation dataset is used to evaluate the performance of predictive models 145 during training. In some embodiments, the training module 160 may use the training sensor data to fine tune and adjust model parameters of the predictive models 145 as needed to improve the performance of the predictive models 145 as determined through said validation. In some embodiments, the training module 160 is configured to apply or adjust hyperparameters like learning rates, regularization strengths, and tree depths to optimize performance of the predictive models 145. Generally, hyperparameters comprise parameters that control the learning process and ultimately determine model parameters (e.g., of predictive models 145) that result from the hyperparameters.

Following training, training module 160 may provide trained predictive models 145 to the testing/validation module 170 for validation. In addition, testing/validation module 170 may assess performance of a respective predictive model 145 by using validation data to evaluate model accuracy. The validation data may be based on historical data and/or past studies. The testing/validation module 170 may evaluate performance of a given predictive model 145 by, e.g., averaging over multiple validation sets or by using specific evaluation metrics.

In some embodiments, the testing/validation module 170 determines an accuracy metric by comparing, for example, a predicted future excursion of a hydrocarbon processing system during a time period with historical performance of the hydrocarbon processing system for the same time period. In some embodiments, training module 160 and testing/validation module 170 are configured to iterate or repeat the training and validation processes described above to optimize and further refine performance of predictive models 145. For example, if the accuracy metric falls below a predefined threshold, the predictive models 145 may receive additional training from training module 160.

Table I presented below represents an exemplary configuration of prediction engine 130 of excursion forecaster 100 in accordance with embodiments disclosed herein. Particularly, Table 1 shows an example illustrating separate or different independent datasets used in training and validating predictive models 145 of the ensemble model 140. It may be understood that the configuration of prediction engine 130 may vary from that shown in Table I below.

TABLE I

| Independent | Dataset | Sensor | Equipment | Predictive |
|---|---|---|---|---|
| Datasets No. | Identifier | No. | Type | Model No. |
| 1 | S₁ | 1 | Scrubber | 1 |
| 2 | S₂ | 2 | Compressor | 2 |
| 3 | S₃ | 3 | Dehydrator | 3 |
| 4 | S₄ | 4 | Thermal unit | 4 |
| — | — | — | — | — |
| — | — | — | — | — |
| — | — | — | — | — |
| N | S_{N} | N | — | N |

As previously described, data collection engine 110 may receive sensor data corresponding to different equipment of a hydrocarbon processing system from a plurality of sensor units coupled to the different equipment (e.g., a first sensor dataset obtained from a first sensor unit coupled to a first piece of equipment, a second sensor dataset obtained from a second sensor unit (different from the first sensor unit) coupled to a second piece of equipment (different from the first piece of equipment), and so on. The sensor data may be real-time sensor data received directly from the sensor units and/or the sensor data may have been previously collected and contained in a historical database. In some embodiments, data collection engine 110 organizes the collected sensor data into independent datasets associated with the sensor units of the hydrocarbon processing system.

In the example presented above in Table I, the data collection engine 110 is configured to receive data from a plurality of sensor units (e.g., sensor units 47, 52, 62, and 82) including a first sensor unit coupled to a scrubber unit (e.g. scrubber sensor unit 47 coupled to scrubber unit 45), a second sensor unit coupled to a compressor unit (e.g., compressor sensor unit 52 coupled to compression unit 50), a third sensor unit coupled to a dehydrator (e.g., dehydrator sensor unit 62 of dehydrator 60), and a fourth sensor unit coupled to a thermal conditioning unit (e.g., thermal conditioning sensor unit 82 coupled to thermal conditioning unit 80). In this example, there are four independent datasets: 1, 2, 3, and 4 corresponding to unique sets of sensor data captured by sensor units 47, 52, 62, and 82, respectively. In this example, independent dataset 1 corresponds to scrubber sensor unit 47 and is identified as S₁, independent dataset 2 corresponds to compressor sensor unit 52 and is identified as S₂, and so on. It should be noted that the data collection engine 110 may be configured to receive data captured by any number of sensor units e.g., N number of sensor units coupled to N number of different equipment where N may be equal to one.

As previously described, excursion forecaster 100 comprises ensemble model 140 for predicting future excursions in a hydrocarbon processing system. In the example presented in Table I, ensemble model 140 of excursion forecaster 100 may comprise four separate predictive models 145. In this example, independent datasets 1, 2, 3, and 4 corresponding to the different equipment is used to train and validate predictive models 1, 2, 3, and 4 (dataset 1 is used for predictive model 1, dataset 2 is used for predictive model 2, and so on). In this manner, each predictive model 1-4 is trained and validated by a unique independent dataset 1-4. In addition, each predictive model 1-4 is trained and validated using a unique dataset whereby no two predictive models are trained using the same dataset.

In some embodiments, predictive models 1, 2, 3, - - - N of the predictive models 145 may comprise multiple instances or multiple types/classes of a single selected predictive model. For example, a decision tree model may be selected as the predictive tool such that predictive models 145 includes 1, 2, 3 - - - N instances or 1, 2, 3 - - - N types of the decision tree model. In this manner, bias and variance associated with conventional predictive models may be mitigated by aggregating the predictions of the multiple predictive models 1, 2, 3 - - - N of predictive models 145 and thereby reduce bias and variance in the overarching ensemble model comprising predictive models 145.

Referring now to FIG. 3, a schematic diagram illustrating an embodiment of a voting classifier ensemble model 300 is shown. Generally, voting classifier ensemble model 300 is used to generate a prediction output (e.g., prediction output 180 of excursion forecaster 100) in accordance with principles disclosed herein. In some embodiments, the excursion forecaster 100 shown in FIG. 2 may comprise the voting classifier ensemble model 300. For example, the ensemble model 140 of excursion forecaster 100 may comprise or at least incorporate some of the features of voting classifier ensemble model 300. However, in other embodiments, ensemble model 140 may not comprise or incorporate the voting classifier ensemble model 300.

In this exemplary embodiment, voting classifier ensemble model 300 produces a final prediction output 305 based on the predictions of each of predictive models 301A-301C contained by the voting classifier ensemble model 300 as well as a predefined voting threshold 306 of the voting classifier model 300 that may vary depending on the given application. In this exemplary embodiment, predictive models 301A-301C each comprise a decision tree voting model having a first or upstream end defined by a root 302 and an opposing downstream end defined by a pair of leaves 304 that are connected to the root 302. In this configuration, predictive models 301A-301C each comprise a so-called “stump” decision tree given that it does not include any intervening nodes located between the root 302 and pair of leaves 304. In some embodiments, the predictive models 301A-301C comprise or are configured similarly as the adaptive boosting or “AdaBoost” model. Individually, predictive models 301A-301C may comprise weak learners having a relatively limited accuracy. However, by combining their independent prediction outputs via a voting mechanism, highly accurate prediction outputs may be obtained from the voting classifier ensemble model 300 even if the accuracy of predictive models 301A-310C is individually limited.

Unlike conventional ensemble models, predictive models 301A-301C comprise the same predictive model (e.g., a decision tree stump) which only diverge upon the application of sensor datasets 291-293 to the respective predictive models 301A-301C during the training of predictive models 301A-301C. Particularly, application of sensor datasets 291-293 to predictive models 301A-301C results in the divergence of the model parameters of predictive models 301A-301C. In this manner, predictive models 301A-301C are of the same model class where the term “model class” as used herein refers to models that are the same prior to the application of training data that may vary in content from model to model.

Also, unlike conventional ensemble models, in the voting classifier ensemble model 300, each of the predictive models 301A-301C is supplied or fed with an independent and unique sensor dataset 291-293 captured from different equipment as previously described. For example, independent dataset 1 of Table I may be partitioned into a first training dataset and a first testing/validation dataset used to train and validate the predictive model 301A of voting classifier ensemble model 300. Similarly, independent dataset 2 of Table I may be partitioned into a second training dataset and a second testing/validation dataset used to train and validate predictive model 301B. Additionally, independent dataset 3 of Table I may be partitioned into a third training dataset and a third testing/validation dataset used to train and validate predictive model 301C.

In some embodiments, relevant features may be extracted from each of the independent datasets 1, 2, and 3 used to train predictive models 301A-301C, respectively. In this manner, predictive models 301A-301C are each trained using a unique dataset and may individually and independently predict an outcome which is fed into predictive models 301A-301C to generate final prediction output 305. For example, predictive models 301A-301C generate prediction outcome 0, 1, and 1 respectively, where a “1” means a future excursion is predicted, and “0” means no future excursion is predicted. Voting classifier ensemble model 300 may be configured to predict a future excursion based on for example, the number of predictive models predicting a future excursion being greater than or equal to a predefined threshold “x”. In this example, in order for the voting classifier ensemble model 300 to vote or output “1” or “yes” at the final prediction output 305, greater or equal to one-third or 33.33% of the predictive models must vote “1” or “yes.” In this manner, at least one of the predictive models 301A-301C must predict a “1” in order for the prediction output (e.g., prediction output 180 of excursion forecaster 100 or final prediction output 305 of voting classifier ensemble model 300) to predict a “1” or “yes,” i.e., a future excursion.

In one non-limiting example, voting classifier ensemble model 300 may predict a future plugging based on independent sensor datasets 291-293 corresponding to scrubber sensor unit 47, compressor sensor unit 52, and dehydrator sensor unit 62 of artificial lift system 10. In some embodiments, voting classifier ensemble model 300 may predict a plugging event in an artificial lift system based only on sensor data such as independent sensor datasets 291-293. In this example, independent datasets 291, 292, and 293 comprise real-time datasets obtained by sensor units 47, 52, and 62 respectively.

In some embodiments, voting classifier ensemble model 300 comprises an adaptive boosting machine learning algorithm (AdaBoost) with same class decision tree predictive models; 301A, 301B, and 301C, each predictive model previously trained and validated using independent datasets corresponding to different equipment of the artificial lift system 10. In this manner, individual prediction outputs from predictive models 301A, 301B, and 301C are combined by the AdaBoost ensemble model to form an ensemble model and generate a final prediction output 305.

In this example, independent sensor dataset 291 may comprise fluid flowrate and fluid composition data from scrubber unit 45 of artificial lift system 10, as well as temperature and pressure data of the fluid passing through the scrubber unit 45 which is captured by scrubber sensor unit 47 and fed to predictive model 301A to provide a first prediction output 303A (indicated as “0” in the example provided in FIG. 3). Similarly, independent dataset 292 may comprise pressure, temperature, and flow rate data of the fluid flowing through compression unit 50 of artificial lift system 10 which is captured by compressor sensor unit 52 and fed to predictive model 301B to provide a second prediction output 303B (indicated as “1” in the example provided in FIG. 3). Likewise, independent dataset 293 may comprise moisture content, pressure, and temperature of dry gas leaving the dehydrator 60 of artificial lift system 10 which is captured by dehydrator sensor unit 62 and fed to predictive model 301C to provide a third prediction output 303C (indicated as “1” in the example provided in FIG. 3). Subsequently, the first, second, and third prediction outputs 303A-303C from predictive models 301A, 301B, and 301C are combined into a final prediction output 305 by applying a predefined voting threshold 306 to the prediction outputs 303A-303C.

As an example, voting classifier ensemble model 300 may be configured to predict a future plugging event in artificial lift system 10 based on the number of predictive models forecasting a future plugging event being greater than or equal to two (2). That is, in order for the voting classifier ensemble model 300 to predict a future plugging event at the final prediction output 305 based on independent datasets 291-293, greater or equal to two of the three predictive models 301A, 301B, and 301C must predict a future plugging event in artificial lift system 10. In this manner, if any two or all three predictive models 301A, 301B, and 301C predict a future plugging event (e.g., have a prediction output 303A-303C corresponding to “1” in this example), prediction output 305 will return a final prediction output 305 indicating a future plugging event in artificial lift system 10. In this manner, operations personnel can proactively implement measures to mitigate or prevent the plugging event when future plugging is predicted. For example, operations personnel may schedule cleaning and maintenance procedures, adjust flow rates, pressure, and temperatures within the artificial lift system, monitor and control fluid compositions, inject chemicals into gas lift system etc., to prevent gas plugging.

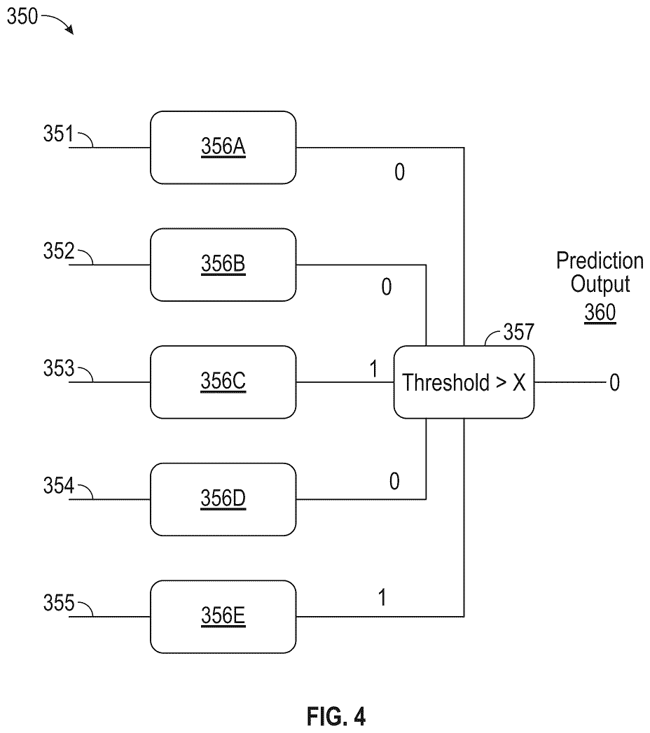

Referring now to FIG. 4, a schematic diagram illustrating another embodiment of a voting classifier ensemble model 350 is shown. The voting classifier ensemble model 350 (similar to voting classifier ensemble model 300 shown in FIG. 3) may be deployed in a pipeline network system to predict a future leak in the pipeline network. In this example, a plurality of sensor units (not shown) may be coupled to a plurality of equipment (e.g., pipelines, pumps, compressor units, valves, scrapers, etc.) of the pipeline network and configured to monitor and capture data associated with pressure, flowrate, temperature, vibration, acoustic emissions and corrosion levels which may be used by the excursion forecaster disclosed herein (e.g., excursion forecaster 100) or voting classifier ensemble model 350 to predict future fluid leakage in the pipeline network system. In this exemplary embodiment, independent sensor datasets 351-355 comprise real-time datasets and are obtained from a plurality of sensor units coupled to a pipeline, pump, compressor unit, valve, and a scraper. Here, the voting classifier ensemble model 350 comprises same class decision tree predictive models; 356A, 356B, 356C, 356D and 356E, each predictive model previously trained and validated using independent datasets corresponding to the different equipment of the pipeline network system.

In this manner, independent dataset 351 corresponds to data captured by a first sensor unit coupled to a pump and comprising vibration, pressure, temperature and flowrate data associated with a pump in the pipeline network system, independent dataset 352 corresponds to data captured by a second sensor unit coupled to a pipeline and comprising acoustic emission data associated with the main pipeline of the pipeline network system, independent dataset 353 corresponds to data captured by a third sensor unit coupled to a compressor unit and comprising pressure, temperature and/or flow rate data associated with fluid flowing through a compressor unit in the pipeline network system, independent dataset 354 corresponds to data captured by a fourth sensor unit coupled to a valve and comprising valve position, and/or flowrate through the valve in the pipeline network system, and independent dataset 355 corresponds to dataset captured by a fifth sensor unit coupled to a scraper and comprising pressure, temperature and/or acoustic data associated with a scraper installed in the pipeline network system.

In this manner, independent datasets 351-355 are fed to predictive models 356A-356E respectively, as previously described with respect to Table 1, and configured to feed their individual prediction outputs into prediction model 357. The prediction model 357 is configured to predict a future fluid leakage in the pipeline network system based on for example, a predefined percentage of the predictive models 356A-356E forecasting a future fluid leakage being greater than or equal to a predefined threshold (e.g., half or 50%) in this example) of the number of predictive models. That is, in order for the voting classifier ensemble model 350 to predict a “1” or future fluid leakage at the prediction output 360 based on independent datasets 351-355, greater than two of the five predictive models 356A-356E, must predict a “1” or future fluid leakage in the pipeline network system. In this manner, if only two or only one of the predictive models 356A-356E predict future fluid leakage, prediction output 360 will return a “0” or no future fluid leakage in the pipeline network system. As illustrated in voting classifier ensemble model 350 of FIG. 4, the prediction output 360 indicates a “0” or no future fluid leakage is predicted because only two (356C and 356E) of the five predictive models; 356A-356E returned a future prediction output of “1” or future fluid leakage.

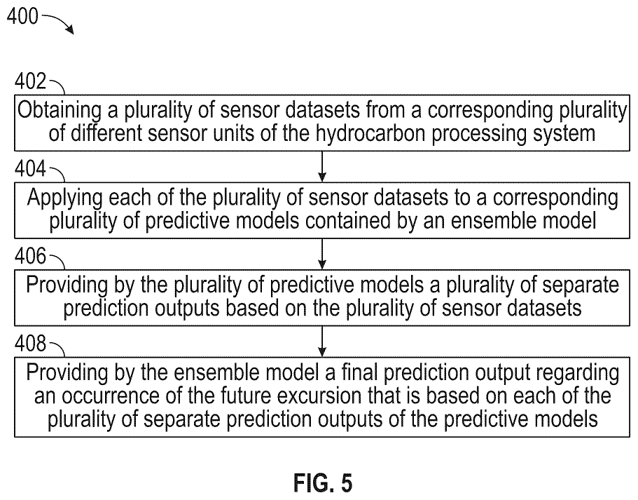

Referring now to FIG. 5, one exemplary method 400 for forecasting future excursions in hydrocarbon processing systems using sensor data in accordance with principles disclosed herein, is shown. Generally, method 400 begins at block 402 with obtaining a plurality of sensor datasets from a corresponding plurality of different sensor units of the hydrocarbon processing system. For example, a sensor dataset N of the plurality of sensor datasets corresponds to a sensor unit N of the plurality of sensor units as illustrated in Table 1 above. Thus, each sensor dataset comprises an independent or unique dataset corresponding to a particular sensor unit of the plurality of different sensor units. Examples of the sensor datasets may include pressure data, temperature data, flow rate data, valve position (open/close) data, etc. Method 400 continues at block 404 with applying each of the plurality of sensor datasets to a corresponding plurality of predictive models contained by an ensemble model. As previously described, each sensor dataset is fed to a different predictive model of the ensemble model, i.e., the sensor dataset N is fed to a predictive model N of a plurality of predictive models. The plurality of predictive models may be same class or different. Method 400 continues at block 406 with providing by the plurality of predictive models a plurality of separate prediction outputs based on the plurality of sensor datasets. Here, each of the plurality of predictive models provides individual or separate prediction output based on the plurality of sensor datasets. Method 400 continues at block 408 with providing by the ensemble model a final prediction output regarding an occurrence of the future excursion that is based on each of the plurality of separate prediction outputs of the predictive models. For example, the final prediction output may be based on a predefined threshold as previously described.

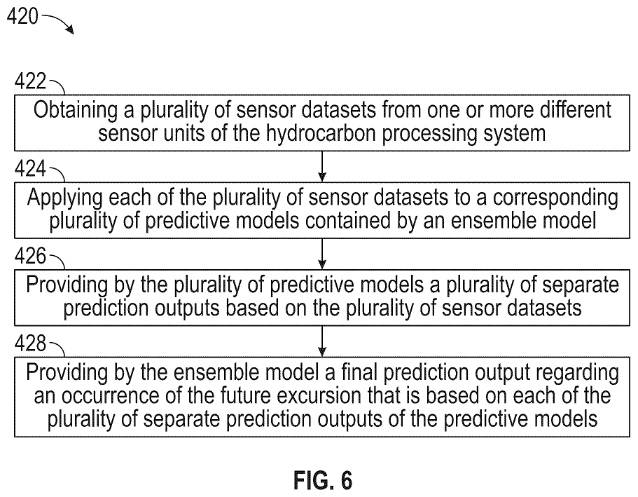

Referring now to FIG. 6, another exemplary method 420 for forecasting future excursions in hydrocarbon processing systems using sensor data in accordance with principles disclosed herein, is shown. Method 420 may include at least some, if not all, of the steps or “blocks” of method 400 shown in FIG. 5. Method 420 begins at block 422 with obtaining a plurality of sensor datasets from one or more different sensor units of the hydrocarbon processing system. The one or more different sensor units may capture data associated with different equipment of a hydrocarbon processing system as previously described. At block 424, method 420 continues with applying each of the plurality of sensor datasets to a corresponding plurality of predictive models contained by an ensemble model, where, each of the predictive models of the plurality of predictive models are of the same model class. Method 420 continues at block 426 with providing by the plurality of predictive models a plurality of separate prediction outputs based on the plurality of sensor datasets. Method 420 continues further to block 428 with providing by the ensemble model a final prediction output regarding an occurrence of the future excursion that is based on each of the plurality of separate prediction outputs of the predictive models.

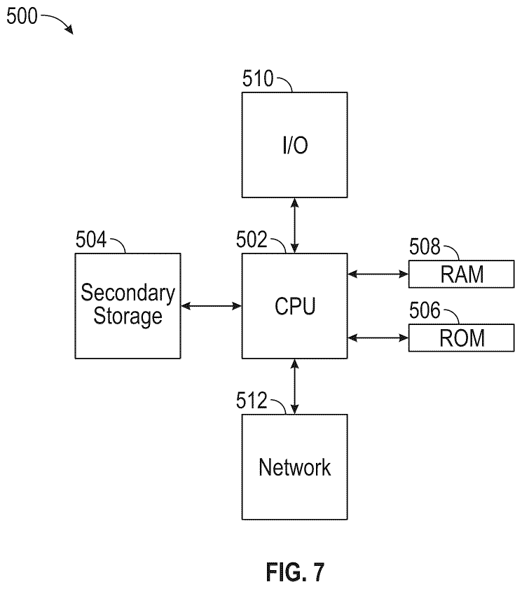

Referring now to FIG. 7, a computer system 500 suitable for implementing one or more embodiments disclosed herein is shown. Any of the systems and methods disclosed herein can be carried out (e.g., entirely or partially) on a computer or other device comprising a processor (e.g., a desktop computer, a laptop computer, a tablet, a server, a smartphone, or some combination thereof). The computer system 500 includes a processor 502 (which may be referred to as a central processor unit or CPU) that is in communication with memory devices including secondary storage 504, read only memory (ROM) 506, random access memory (RAM) 508, input/output (I/O) devices 510, and network connectivity devices 512. The processor 502 may be implemented as one or more CPU chips. In some embodiments, processor 502 may be implemented as one or more graphics processing units (GPUs).

It is understood that by programming and/or loading executable instructions onto the computer system 500, at least one of the CPUs 502, the RAM 508, and the ROM 506 are changed, transforming the computer system 500 in part into a particular machine or apparatus having the novel functionality taught by the present disclosure. Thus, the RAM 508 and/or the ROM 506 may comprise a non-transitory machine-readable (or computer-readable) medium that may include instructions (which may be referred to herein as machine-readable instructions) that are executable by CPU 502 to provide functionality to computer system 500. Thus, in some embodiments, a machine-readable instructions stored on a memory may be executed on a processor, so as to configured the processor to carry out some or all of the features of the methods described herein (e.g., methods 400, 420).

It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware (for example in an application specific integrated circuit (ASIC), or field-programmable gate arrays (FPGA)) because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the computer system 500 is turned on or booted, the CPU 502 may execute a computer program or application. For example, the CPU 502 may execute software or firmware stored in the ROM 506 or stored in the RAM 508. In some cases, on boot and/or when the application is initiated, the CPU 502 may copy the application or portions of the application from the secondary storage 504 to the RAM 508 or to memory space within the CPU 502 itself, and the CPU 502 may then execute instructions of which the application is comprised. In some cases, the CPU 502 may copy the application or portions of the application from memory accessed via the network connectivity devices 512 or via the I/O devices 510 to the RAM 508 or to memory space within the CPU 502, and the CPU 502 may then execute instructions of which the application is comprised. During execution, an application may load instructions into the CPU 502, for example load some of the instructions of the application into a cache of the CPU 502. In some contexts, an application that is executed may be said to configure the CPU 502 to do something, e.g., to configure the CPU 502 to perform the function or functions promoted by the subject application. When the CPU 502 is configured in this way by the application, the CPU 502 becomes a specific purpose computer or a specific purpose machine.

The secondary storage 504 is typically comprised of one or more disk drives or tape drives and is used for non-volatile storage of data and as an over-flow data storage device if RAM 508 is not large enough to hold all working data. Secondary storage 504 may be used to store programs which are loaded into RAM 508 when such programs are selected for execution. The ROM 506 is used to store instructions and perhaps data which are read during program execution. ROM 506 is a non-volatile memory device which typically has a small memory capacity relative to the larger memory capacity of secondary storage 504. The RAM 508 is used to store volatile data and perhaps to store instructions. Access to both ROM 506 and RAM 508 is typically faster than secondary storage 504. The secondary storage 504, the RAM 508, and/or the ROM 506 may be referred to in some contexts as computer readable storage media and/or non-transitory computer readable media.

I/O devices 510 may include printers, video monitors, electronic displays (e.g., liquid crystal displays (LCDs), plasma displays, organic light emitting diode displays (OLED), touch sensitive displays, etc.), keyboards, keypads, switches, dials, mice, track balls, voice recognizers, card readers, paper tape readers, or other well-known input devices.

The network connectivity devices 512 may take the form of modems, modem banks, Ethernet cards, Omni-Path Architecture (OPA), InfiniBand (IB), universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 512 may enable the processor 502 to communicate with the Internet or one or more intranets. With such a network connection, it is contemplated that the processor 502 might receive information from the network, or might output information to the network (e.g., to an event database) in the course of performing the methods described herein. Such information, which is often represented as a sequence of instructions to be executed using processor 502, may be received from and outputted to the network, for example, in the form of a computer data signal embodied in a carrier wave.

Such information, which may include data or instructions to be executed using processor 502 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several known methods. The baseband signal and/or signal embedded in the carrier wave may be referred to in some contexts as a transitory signal.

The processor 502 executes instructions, codes, computer programs, scripts which it accesses from hard disk, floppy disk, optical disk, solid state drives (SSD) (these various disk-based systems may all be considered secondary storage 504), flash drive, ROM 506, RAM 508, or the network connectivity devices 512. While only one processor 502 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 504, for example, hard drives, floppy disks, optical disks, and/or other device, the ROM 506, and/or the RAM 508 may be referred to in some contexts as non-transitory instructions and/or non-transitory information.

In an embodiment, the computer system 500 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 500 to provide the functionality of a number of servers that is not directly bound to the number of computers in the computer system 500. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the computer system 500, at least portions of the contents of the computer program product to the secondary storage 504, to the ROM 506, to the RAM 508, and/or to other non-volatile memory and volatile memory of the computer system 500. The processor 502 may process the executable instructions and/or data structures in part by directly accessing the computer program product, for example by reading from a CD-ROM disk inserted into a disk drive peripheral of the computer system 500. Alternatively, the processor 502 may process the executable instructions and/or data structures by remotely accessing the computer program product, for example by downloading the executable instructions and/or data structures from a remote server through the network connectivity devices 512. The computer program product may comprise instructions that promote the loading and/or copying of data, data structures, files, and/or executable instructions to the secondary storage 504, to the ROM 506, to the RAM 508, and/or to other non-volatile memory and volatile memory of the computer system 500.

In some contexts, the secondary storage 504, the ROM 506, and the RAM 508 may be referred to as a non-transitory computer readable medium or a computer readable storage media. A dynamic RAM embodiment of the RAM 508, likewise, may be referred to as a non-transitory computer readable medium in that while the dynamic RAM receives electrical power and is operated in accordance with its design, for example during a period of time during which the computer system 500 is turned on and operational, the dynamic RAM stores information that is written to it. Similarly, the processor 502 may comprise an internal RAM, an internal ROM, a cache memory, and/or other internal non-transitory storage blocks, sections, or components that may be referred to in some contexts as non-transitory computer readable media or computer readable storage media. At least some, if not all, of the steps or “blocks” of method 400 and 420 shown in FIGS. 5 and 6 respectively, may be executed by the computer system 500 shown in FIG. 7, although it is to be understood that at least some of the steps of methods 400 and 420 may be executed by systems other than computer system 500.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A method for predicting a future excursion in a hydrocarbon processing system, the method comprising:
obtaining a plurality of sensor datasets from a corresponding plurality of different sensor units of the hydrocarbon processing system, wherein a sensor dataset N of the plurality of sensor datasets corresponds to a sensor unit N of the plurality of different sensor units;
applying each of the plurality of sensor datasets to a corresponding plurality of predictive models contained by an ensemble model, wherein the sensor dataset N corresponds to a predictive model N of the plurality of predictive models;
providing by the plurality of predictive models a plurality of separate prediction outputs based on the plurality of sensor datasets; and
providing by the ensemble model a final prediction output regarding an occurrence of the future excursion that is based on each of the plurality of separate prediction outputs of the predictive models.

2. The method of claim 1, wherein each of the plurality of predictive models is configured to predict the future excursion based on data corresponding to the hydrocarbon processing system.

3. The method of claim 1, wherein the plurality of predictive models comprises a voting classifier of ensemble models.

4. The method of claim 3, wherein each of the plurality of predictive models comprises different models.

5. The method of claim 1, wherein the hydrocarbon processing system comprises an artificial lift or a gas lift system.

6. The method of claim 1, wherein the future excursion includes gas lift plugging.

7. The method of claim 1, wherein a prediction window of the future excursion comprises less than twelve hours in advance of the future excursion.

8. The method of claim 1, wherein data captured by the plurality of different sensors units comprises time series data.

9. The method of claim 8, wherein the time series data comprises pressure data, temperature data, or flow rate data.

10. The method of claim 1, wherein the final prediction output is based on a predefined threshold that is different from a majority of the plurality of predictive models.

11. A method for predicting a future excursion in a hydrocarbon processing system, the method comprising:
obtaining a plurality of sensor datasets from one or more different sensor units of the hydrocarbon processing system;
applying each of the plurality of sensor datasets to a corresponding plurality of predictive models contained by an ensemble model, wherein each of the predictive models of the plurality of predictive models are of a same model class;
providing by the plurality of predictive models a plurality of separate prediction outputs based on the plurality of sensor datasets; and
providing by the ensemble model a final prediction output regarding an occurrence of the future excursion that is based on each of the plurality of separate prediction outputs of the predictive models.

12. The method of claim 11, wherein each of the plurality of predictive models is configured to predict the future excursion based on data corresponding to the hydrocarbon processing system.

13. The method of claim 11, wherein the plurality of predictive models comprises a voting classifier of ensemble models.

14. The method of claim 11, wherein the hydrocarbon processing system comprises an artificial lift or a gas lift system.

15. The method of claim 11, wherein the future excursion includes gas lift plugging.

16. The method of claim 11, wherein a prediction window of the future excursion comprises less than twelve hours in advance of the future excursion.

17. The method of claim 11, wherein data captured by the one or more different sensors units comprises time series data.

18. The method of claim 17, wherein the time series data comprises pressure data, temperature data, or flow rate data.

19. The method of claim 11, wherein the final prediction output is based on a predefined threshold that is different from a majority of the plurality of predictive models.

20. A system for predicting a future excursion in a hydrocarbon processing system, the system comprising:
a one or more processors; and
a storage device coupled to the one or more processors, the storage device configured to store instructions that, when executed by the one or more processors, configure the one or more processors to:
obtain a plurality of sensor datasets from a corresponding plurality of different sensor units of the hydrocarbon processing system, wherein a sensor dataset N of the plurality of sensor datasets corresponds to a sensor unit N of the plurality of different sensor units;
apply each of the plurality of sensor datasets to a corresponding plurality of predictive models contained by an ensemble model, wherein the sensor dataset N corresponds to a predictive model N of the plurality of predictive models;
provide by the plurality of predictive models a plurality of separate prediction outputs based on the plurality of sensor datasets; and
provide by the ensemble model a final prediction output regarding an occurrence of the future excursion that is based on each of the plurality of separate prediction outputs of the predictive models.

21. A fluid processing system comprising:
a plurality of equipment;
a plurality of sensors units, wherein a sensor unit of the plurality of sensor units is coupled to an equipment of the plurality of equipment; and
a computing device comprising the system of claim 20.
